(19) United States
(12) Patent Application Publication
(10) Pub. No.: US 2014/0103117 A1
(43) Pub. Date: Apr. 17, 2014

(54) RFID TAG

(71) Applicant: FUJITSU LIMITED, Kanagawa (JP)

(72) Inventors: Shuichi TAKEUCHI, Chikuma (JP); Norio KAINUMA, Nagano (JP); Kuniko ISHIKAWA, Nagano (JP); Tetsuya TAKAHASHI, Nagano (JP); Kenji KOBAE, Nagano (JP)

(73) Assignee: FUJITSU LIMITED, Kanagawa (JP)

(21) Appl. No.: 13/969,973

(22) Filed: Aug. 19, 2013

(30) Foreign Application Priority Data
Oct. 17, 2012 (JP) 2012-230090

(51) Int. Cl. G06K 19/077

(52) U.S. Cl. CPC G06K 19/07775
USPC 235/492

(57) ABSTRACT

There is provided an RFID tag, which includes: a first substrate having flexibility and configured to include an antenna provided on a first surface of the first substrate; a second substrate; an IC chip mounted on a first surface of the second substrate; an anisotropic conductive rubber configured to contact the first substrate to the second substrate with the IC chip facing the first surface of the first substrate and to contact a terminal of the IC chip to the antenna; and an exterior rubber configured to cover the first substrate, the second substrate, and the IC chip.

### CROSS-REFERENCE TO RELATED APPLICATION

This application is based upon and claims the benefit of priority of the prior Japanese Patent Application No. 2012-230090, filed on Oct. 17, 2012, the entire contents of which are incorporated herein by reference.

### FIELD

The embodiments discussed herein are related to a radio frequency identifier (RFID) tag.

### BACKGROUND

Japanese Laid-open Patent Publication No. 2005-056362 discusses an integrated circuit (IC) tag including an IC chip, a circuit part having an external connection function, urethane resin stuck onto both upper and lower surfaces of the circuit unit, and a silicone film that coats the entire surfaces of the urethane resin.

### SUMMARY

According to an aspect of the invention, an RFID tag includes: a first substrate having flexibility and configured to include an antenna provided on a first surface of the first substrate; a second substrate; an IC chip mounted on a first surface of the second substrate; an anisotropic conductive rubber configured to contact the first substrate to the second substrate with the IC chip facing the first surface of the first substrate and to contact a terminal of the IC chip to the antenna; and an exterior rubber configured to cover the first substrate, the second substrate, and the IC chip.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1C illustrate an RFID tag;

FIGS. 2A and 2B illustrate an RFID tag according to a first embodiment;

FIGS. 3A and 3B illustrate an antenna in the RFID tag of the first embodiment;

FIGS. 4A and 4B illustrate wiring layers on a sub-substrate in the RFID tag of the first embodiment;

FIGS. 5A to 5C illustrate manufacturing steps for the RFID tag of the first embodiment;

FIGS. 6A to 6C illustrate manufacturing steps for the RFID tag of the first embodiment;

FIGS. 7A to 7D illustrate manufacturing steps for the RFID tag of the first embodiment;

FIG. 8 illustrates a state in which the RFID tag of the first embodiment is sewn on a T-shirt;

FIG. 9 illustrates a dewaterer that performs press extraction;

FIG. 10 is a cross-sectional view illustrating a deformed state of the RFID tag of the first embodiment;

FIGS. 11A and 11B are cross-sectional views illustrating a state in which the RFID tag illustrated in FIG. 1 receives external stress; and

FIG. 12 is a cross-sectional view of an RFID tag according to a second embodiment.

### DESCRIPTION OF EMBODIMENTS

For example, IC tags of the related art may be attached to sheets or towels commercially used at hotels or table napkins or hand towels commercially used at restaurants (hereinafter collectively referred to as sheets).

However, since commercial sheets are used and washed over and over, for example, they are collected from various hotels or restaurants to a plant of a laundry service provider, where they are washed together.

When extracting water from laundry, such as sheets, after washing the laundry with water, for example, the laundry service provider sometimes puts a large amount of laundry in a huge container and extracts water from the laundry by pressing the laundry with a huge piston from above the container in order to enhance washing efficiency (hereinafter this method of water extraction is referred to as press extraction).

For example, when the container used for such press extraction is cylindrical, the container and the piston sometimes have diameters of several meters. Further, for example, a pressure of 30 to 50 kgf/cm² is applied to the laundry from the piston.

For this reason, for example, when sheets with IC tags of the related art are subjected to press extraction over and over, the IC tags are sometimes damaged by a breakage in connecting portions between the IC chip and the circuit part and a breakage of the circuit part itself.

Embodiments that may provide highly durable RFID tags will be described below.

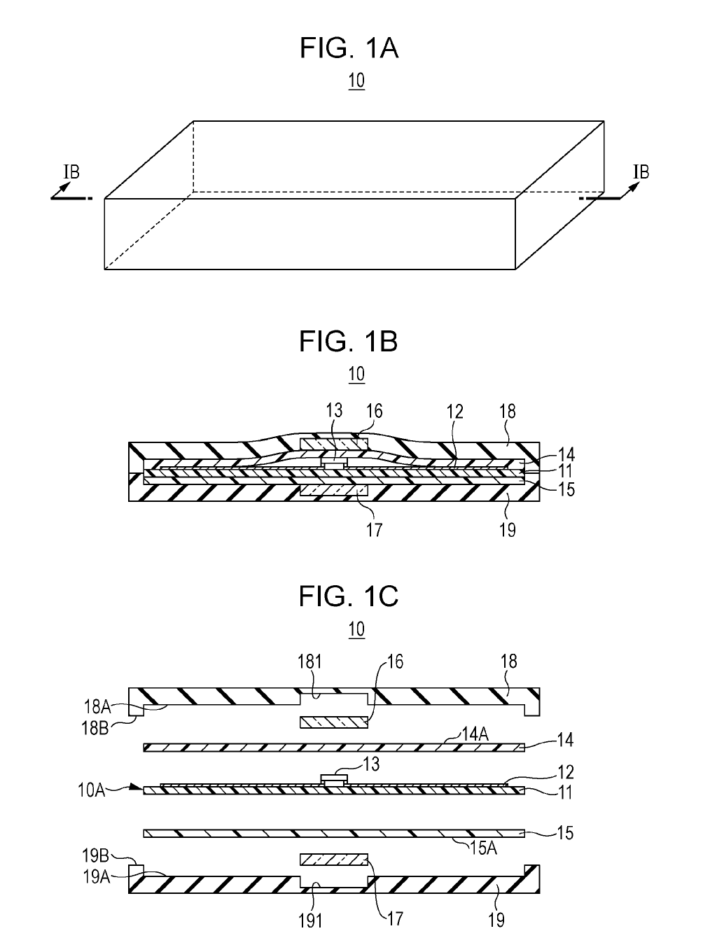

FIGS. 1A to 1C illustrate an RFID tag 10. FIG. 1A is a perspective view of the RFID tag 10, FIG. 1B is a cross-sectional view taken along line IB-IB of FIG. 1A, and FIG. 1C is an exploded sectional view of the RFID tag 10. The cross section of FIG. 1C corresponds to the cross section of FIG. 1B.

As illustrated in FIGS. 1A to 1C, the RFID tag 10 includes a base part 11, an antenna 12, an IC chip 13, protective sheets 14 and 15, reinforcing parts 16 and 17, and cover parts 18 and 19.

Hereinafter, a surface provided on an upper side in the figures is referred to as a front surface or an upper surface, and a surface provided on a lower side in the figures is referred to as a back surface or a lower surface. However, these are defined for convenience of explanation, and do not universally refer to the front surface or the upper surface and the back surface or the lower surface.

The base part 11 is a sheet-shaped member having flexibility. On one surface of the base part 11, the antenna 12 is formed, and the IC chip 13 is mounted.

For example, the base part 11 may be a polyethylene terephthalate (PET) film. Also, for example, the base part 11 may be formed by extrusion.

The antenna 12 is provided on the one surface of the base part 11. For example, the antenna 12 is formed of silver paste.

The IC chip 13 is mounted on the one surface of the base part 11, and is electrically connected to the antenna 12.

When the IC chip 13 receives a read signal in a radio frequency (RF) band via the antenna 12 from a reader/writer of the RFID tag 10, it operates with power from the received RF signal, and transmits identification information via the antenna 12. Thus, the identification information about the RFID tag 10 is read by the reader/writer.

The base part 11, the antenna 12, and the IC chip 13 constitute an inlet 10A.

The protective sheets 14 and 15 are sheet-shaped members having flexibility, and are attached to one and the other surfaces of the base part 11 with adhesive layers, respectively.

The protective sheet 14 covers and protects the antenna 12 and the IC chip 13 provided on the front surface of the base part 11. The protective sheet 15 covers the other surface of the base part 11, and protects the antenna 12 and the IC chip 13 with the base part 11 being disposed therebetween.

For example, the protective sheets 14 and 15 may be formed by PET (polyethylene terephthalate) films, and may be produced by extrusion.

In plane view, the size of the protective sheets 14 and 15 is equal to the size of the base part 11. This is because the protective sheets 14 and 15 protect the antenna 12 formed on the base part 11 and the IC chip 13 mounted on the base part 11.

The reinforcing part 16 is bonded to a portion of a front surface 14A of the protective sheet 14 located on the IC chip 13 and a connecting portion between the IC chip 13 and the antenna 12. That is, the reinforcing part 16 covers the IC chip 13 and the connecting portion between the IC chip 13 and the antenna 12 with the protective sheet 14 being disposed therebetween.

For example, the reinforcing part 16 is formed by a glass epoxy substrate, and is bonded to the front surface 14A of the protective sheet 14 with adhesive.

In plane view, the reinforcing part 16 is larger than the IC chip 13. That is, in plan view, the size (area) of the reinforcing part 16 is larger than the size (area) of the IC chip 13. Further, the reinforcing part 16 is bonded to the front surface 14A of the protective sheet 14 such that the IC chip 13 is located at almost the center of the reinforcing part 16 in plan view.

The reinforcing part 17 is bonded to a portion of a back surface 15A of the protective sheet 15 located under the IC chip 13 and a connecting portion between the IC chip 13 and the antenna 12. That is, the reinforcing part 17 covers the IC chip 13 and the connecting portion between the IC chip 13 and the antenna 12 with the protective sheet 15 being disposed therebetween.

For example, the reinforcing part 17 is formed by a glass epoxy substrate, and is bonded to the back surface 15A of the protective sheet 15.

The reinforcing part 17 has the same size as that of the reinforcing part 16. Similarly to the reinforcing part 16, the reinforcing part 17 is bonded to the back surface 15A of the protective sheet 15 such that the IC chip 13 is located at almost the center of the reinforcing part 17 in plan view.

The cover part 18 is provided on the protective sheet 14 and the reinforcing part 16 to cover the protective sheet 14 and the reinforcing part 16. The cover part 18 includes a recess 18A receding from a bottom face side of a rectangular parallelepiped, and a peripheral portion 18B. The peripheral portion 18B is provided along an outer periphery of the cover part 18 in the form of a rectangular ring in plan view, and surrounds the recess 18A. In the center of the recess 18A, a depression 181 is provided to receive the reinforcing part 16. For example, the cover part 18 may be formed of a rubber material.

The cover part 19 is provided under the protective sheet 15 and the reinforcing part 17 to cover the protective sheet 15 and the reinforcing part 17. The cover part 19 includes a recess 19A receding from an upper surface side of the rectangular parallelepiped, and a peripheral portion 19B. The peripheral portion 19B is provided along an outer periphery of the cover part 19 in the form of a rectangular ring in plan view, and surrounds the recess 19A. In the center of the recess 19A, a depression 191 is provided to receive the reinforcing part 17. For example, the cover part 19 may be formed of a rubber material.

The cover parts 18 and 19 tightly seal the base part 11, the antenna 12, the IC chip 13, the protective sheets 14 and 15, and the reinforcing parts 16 and 17 with the peripheral portions 18B and 19B being bonded to each other. For example, the peripheral portions 18B and 19B may be bonded with adhesive.

### First Embodiment

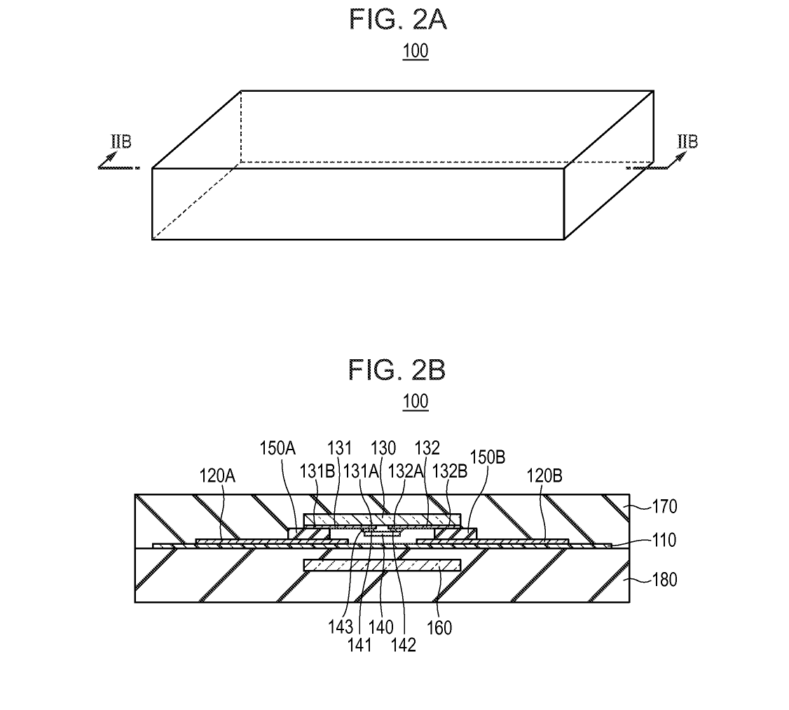

FIG. 2A is a perspective view of an RFID tag 100 according to a first embodiment, and FIG. 2B is a cross-sectional view, taken along line IIB-IIB of FIG. 2A.

The RFID tag 100 of the first embodiment includes a substrate 110, an antenna 120 (120A, 120B), a sub-substrate 130, an IC chip 140, anisotropic conductive rubbers 150 (150A, 150B), a sub-substrate 160, and cover parts 170 and 180.

The substrate 110, the antenna 120 (120A, 120B), the sub-substrate 130, the IC chip 140, the anisotropic conductive rubbers 150 (150A, 150B), and the sub-substrate 160 constitute an inlet.

The substrate 110 is a sheet-shaped member having flexibility, and is an example of a first substrate. On one surface of the substrate 110, the antenna 120 is formed, and the sub-substrate 130 is mounted with the anisotropic conductive rubbers 150 being disposed therebetween. The IC chip 140 is mounted on the sub-substrate 130. The sub-substrate 130 is an example of a second substrate.

For example, the substrate 110 is 40 mm in lateral length in FIG. 2B, 7 mm in depth, and 0.05 mm in thickness.

For example, the substrate 110 may be a polyethylene terephthalate (PET) film, and may be produced by extrusion.

The flexible member that forms the substrate 110 is not limited to the PET film, and may be, for example, a polypropylene film or a vinyl chloride film.

The antenna 120 includes antenna parts 120A and 120B provided on one surface of the substrate 110. For example, the antenna 120 is formed of silver paste. As the silver paste, a paste in which silver powder is mixed in thermosetting resin may be used. By applying the silver paste on the front surface of the substrate 110 and thermally setting the silver paste by heating, the antenna 120 is formed. For example, the antenna 120 is 0.05 mm in thickness.

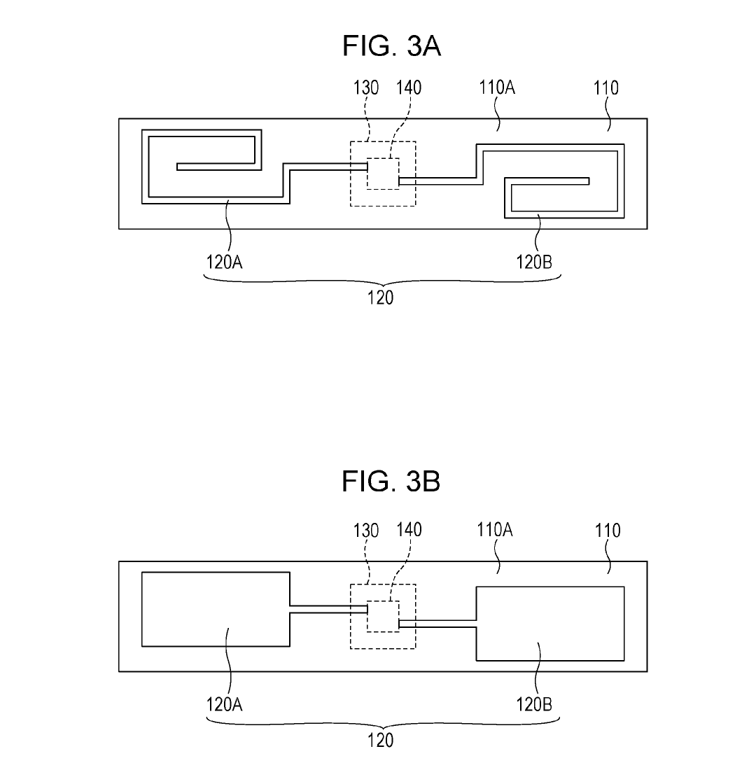

A pattern of the antenna 120 in plan view will be described below with reference to FIGS. 3A and 3B.

The sub-substrate 130 is mounted on the front surface of the substrate 110 with the anisotropic conductive rubbers 150 (150A, 150B) being disposed therebetween. For example, the sub-substrate 130 is a platelike member that is 7 mm in lateral length in FIG. 2B, 7 mm in depth, and 0.5 mm in thickness. In plan view, the sub-substrate 130 is larger than the IC chip 140, and the IC chip 140 is provided at the center of the sub-substrate 130.

For example, the sub-substrate 130 may be formed by a flame retardant type 4 (FR-4) standard glass epoxy substrate. The glass epoxy substrate is formed by attaching copper foil to one surface of a glass cloth base that is impregnated with epoxy resin. By patterning the copper foil, wiring layers 131 and 132 are formed on a lower surface of the sub-substrate 130, as illustrated in FIG. 2B.

The sub-substrate 130 is used as a substrate having the IC chip 140 mounted on its lower surface, and also serves to protect the IC chip 140. Hence, the sub-substrate 130 preferably has a certain degree of hardness. For this reason, it is satisfactory as long as the sub-substrate 130 is a hard substrate having rigidity higher than or equal to a predetermined Young's modulus, and the sub-substrate 130 may be formed by a substrate different from the glass epoxy substrate.

Ends 131A and 132A of the wiring layers 131 and 132 are provided on the lower surface of the sub-substrate 130, and are connected to communication terminals of the IC chip 140 via bumps 141 and 142, respectively. The IC chip 140 is mounted on the sub-substrate 130 with an underfill part 143 being disposed therebetween.

The other ends 131B and 132B of the wiring layers 131 and 132 are connected to the antenna parts 120A and 120B via the anisotropic conductive rubbers 150A and 150B, respectively. In this way, the sub-substrate 130 is mounted on the front surface of the substrate 110 with the anisotropic conductive rubbers 150A and 150B being disposed therebetween.

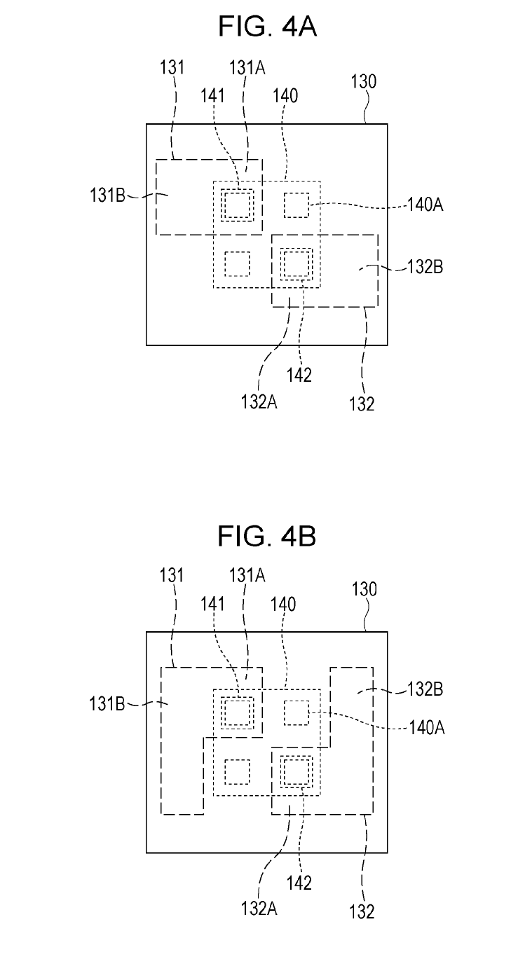

Patterns of the wiring layers 131 and 132 in plan view will be described below with reference to FIGS. 4A and 4B.

The IC chip 140 is similar to the IC chip 13 illustrated in FIGS. 1B and 1C. When the IC chip 140 receives a read signal in an RF band via the antenna 120 from a reader/writer of the RFID tag 100, it operates with power from the received signal, and transmits identification information via the antenna 120. Thus, the identification information about the RFID tag 100 is read by the reader/writer.

For example, the IC chip 140 has a size of 0.5×0.5 mm in plan view, and is 0.1 mm in thickness.

The anisotropic conductive rubbers 150A and 150B connect the antenna parts 120A and 120B of the antenna 120 provided on the front surface of the substrate 110 to the wiring layers 131 and 132 of the sub-substrate 130, respectively. The anisotropic conductive rubbers 150A and 150B are similar except that they are connected to different destinations. Hereinafter, the anisotropic conductive rubbers 150A and 150B are collectively referred to as anisotropic conductive rubbers 150 when they are not particularly distinguished from each other.

For example, each of the anisotropic conductive rubbers 150 is an anisotropic conductive rubber member including a silicone rubber sheet and a lot of metal wires penetrating the silicone rubber sheet in the thickness direction. The anisotropic conductive rubbers 150 exhibit conductivity in the thickness direction of the silicon rubber sheet, but do not exhibit conductivity in the width direction of the silicon rubber sheet. The metal wires may penetrate the silicone rubber sheet in a direction at an angle to the thickness direction of the silicon rubber sheet.

Since each of the anisotropic conductive rubbers 150 has conductivity in the thickness direction and also has elasticity and flexibility because of silicone rubber, it deforms in the thickness direction and further deforms in a direction at an angle to the thickness direction (in a panning direction).

For example, the anisotropic conductive rubbers 150 are 3 mm in lateral direction of FIG. 2B, 7 mm in depth, and 0.2 mm in thickness.

When the substrate 110, the antenna 120, the sub-substrate 130, the IC chip 140, the anisotropic conductive rubbers 150, and the sub-substrate 160 are tightly sealed by the cover parts 170 and 180, the anisotropic conductive rubbers 150 are pressed in the thickness direction to connect the antenna parts 120A and 120B of the antenna 120 to the wiring layers 131 and 132, respectively.

When stress is applied to the cover parts 170 and 180, the anisotropic conductive rubbers 150 deform in the thickness direction to a thickness of about 0.14 mm.

Preferably, the thickness of the anisotropic conductive rubbers 150 is more than that of the IC chip 140. This is because a space having a height more than the thickness of the IC chip 140 is ensured between the sub-substrate 130 and the substrate 110 so that the IC chip 140 mounted on the lower surface of the sub-substrate 130 does not touch the substrate 110 (or the antenna parts 120A and 120B).

Preferably, the thickness of the anisotropic conductive rubbers 150 is more than that of the IC chip 140 in a state in which the anisotropic conductive rubbers 150 are maximally deformed in the thickness direction (maximally contracted in the thickness direction). In this case, the IC chip 140 mounted on the lower surface of the sub-substrate 130 does not touch the substrate 110 (or the antenna parts 120A and 120B) even in a state in which the anisotropic conductive rubbers 150 are contracted by external stress received by the RFID tag 100.

The sub-substrate 160 is provided near the center in the width direction of the cover part 180 on the back surface side of the substrate 110. For example, the sub-substrate 160 may be formed by a glass epoxy substrate, but does not include copper foil. In this point, the sub-substrate 160 is different from the sub-substrate 130.

The cover parts 170 and 180 are examples of exterior rubbers that tightly seal the substrate 110, the antenna 120, the sub-substrate 130, the IC chip 140, the anisotropic conductive rubbers 150 (150A, 150B), and the sub-substrate 160. The cover part 170 is an example of a first exterior rubber portion, and the cover part 180 is an example of a second exterior rubber portion.

It is satisfactory as long as the cover parts 170 and 180 are formed of a material having elasticity and flexibility. For example, the cover parts 170 and 180 may be formed of a material having entropy elasticity. For example, entropy elasticity includes rubber elasticity and elastomer elasticity. For this reason, as the material having flexibility and elasticity for forming the cover part 180, a rubber material having rubber elasticity or an elastomer material having elastomer elasticity may be used.

Examples of rubber materials are silicone (silica ketone) rubber, butyl rubber, nitrile rubber, hydrogenated nitrile rubber, fluororubber, epichlorohydrin rubber, isoprene rubber, chlorosulfonated polyethylene rubber, and urethane rubber.

Examples of elastomer materials are vinyl chroride elastomer, styrene elastomer, olefin elastomer, ester elastomer, urethane elastomer, and amide elastomer.

Since it is satisfactory as long as the cover parts 170 and 180 have flexibility and elasticity, the material thereof is not limited to the above materials, and is also not limited to the material having entropy elasticity.

The cover part 170 is shaped like a thin plate, and the cover part 180 is shaped like a thin plate having a hollow on an upper side. In the hollow of the cover part 180, the sub-substrate 160 is buried. When the same rubber material as that of the cover part 180 is applied on the upper surface of the sub-substrate 160, the cover part 180 encloses the sub-substrate 160.

For example, the cover part 180 having the hollow may be formed by calendaring with a calendar roll or by extrusion. Further, the lower surface of the cover part 170 may be provided with a hollow that receives the sub-substrate 130 and the anisotropic conductive rubbers 150.

By bonding the peripheral portions of the cover parts 170 and 180 while the cover parts 170 and 180. The substrate 110, the antenna 120, the sub-substrate 130, the IC chip 140, the anisotropic conductive rubbers 150, and the sub-substrate 160 are held therebetween, these elements are tightly sealed by the cover parts 170 and 180.

In this state, portions of the cover part 170 in contact with the substrate 110, the antenna 120, the sub-substrate 130, the anisotropic conductive rubbers 150, and the sub-substrate 160 are depressed, and the cover parts 170 and 180 are combined to form an outer shape like a rectangular parallelepiped, as illustrated in FIG. 2A.

The cover parts 170 and 180 are examples of exterior members, and for example, the peripheral portions of the cover parts 170 and 180 may be bonded with adhesive such as acrylic adhesive (tape-shaped). Alternatively, the peripheral portions of the cover parts 170 and 180 may be heat-sealed.

Next, the shape (pattern) of the antenna 120 will be described with reference to FIGS. 3A and 3B.

FIGS. 3A and 3B illustrate the antenna 120 in the RFID tag 100 of the first embodiment. For example, the antenna 120 may have a shape illustrated in FIG. 3A or 3B. In FIGS. 3A and 3B, the outlines of the sub-substrate 130 and the IC chip 140 are depicted by broken lines to demonstrate the relationship between the positions of the sub-substrate 130 and the IC chip 140 with the position of the antenna 120.

As illustrated in FIG. 3A, the antenna 120 is formed by the antenna parts 120A and 120B provided on one surface 110A of the substrate 110, the antenna parts 120A and 120B have patterns bent in a rectangular form in plan view.

The antenna parts 120A and 120B form monopole antennas. The length as the antenna includes the sum of the height of the anisotropic conductive rubbers 150A and 150B and the length of the wiring layers 131 and 132, and is set to be ¼ of the wavelength (λ) of the used frequency of the RFID tag 100 (λ/4).

That is, the length of the antenna parts 120A and 120B is obtained by extracting the height of the anisotropic conductive rubbers 150A and 150B and the length of the wiring layers 131 and 132 from ¼ of the wavelength (λ) of the used frequency of the RFID tag 100 (λ/4). This is because the anisotropic conductive rubbers 150A and 150B and the wiring layers 131 and 132 substantially function as a part of the antenna.

The length of the antenna parts 120A and 120B may be set to be ¼ of the wavelength (λ) of the used frequency of the RFID tag 100 (λ/4). For example, when the anisotropic conductive rubbers 150A and 150B and the wiring layers 131 and 132 do not have any influence on the radiation characteristics of the antenna parts 120A and 120B because of the impedance of the anisotropic conductive rubbers 150A and 150B, the length of the antenna parts 120A and 120B may be set to be ¼ of the wavelength (λ) of the used frequency of the RFID tag 100 (λ/4).

When distal ends of the antenna parts 120A and 120B of the antenna 120 are patterned to be bent in a rectangular form in plan view, as illustrated in FIG. 3A, the sizes of the substrate 110 and the cover parts 170 and 180 may be made smaller than when the antenna parts 120A and 120B are patterned in a linear form.

When the distal ends of the antenna parts 120A and 120B of the antenna 120 are bent in a rectangular form in plan view, the lengths of the substrate 110 and the cover parts 170 and 180 in the lateral direction in FIG. 2B may be reduced to about ⅔ of the lengths obtained when the antenna parts 120A and 120B are patterned in a linear form.

Alternatively, as illustrated in FIG. 3B, the distal ends of the antenna parts 120A and 120B of the antenna 120 may be shaped in a wide rectangular form.

Next, the shape of the wiring layers 131 and 132 provided on the sub-substrate 130 will be described with reference to FIGS. 4A and 4B.

FIGS. 4A and 4B are enlarged top views of the wiring layers 131 and 132 provided on the sub-substrate 130 in the RFID tag 100 of the first embodiment, through which the IC chip 140 and the bumps 141 and 142 are seen.

As illustrated in FIG. 4A, the IC chip 140 has one terminal 140A at each of the four corners (four terminals 140A in total). On the sub-substrate 130 illustrated in FIG. 4A, the wiring layers 131 and 132 are both patterned in a rectangular form, and are located at positions corresponding to two terminals 140A on a diagonal line, of the four terminals 140A.

Ends 131A and 132A of the wiring layers 131 and 132 are connected to the two terminals 140A on the diagonal line, of the four terminals, via bumps 141 and 142, respectively. Further, the other ends 131B and 132B of the wiring layers 131 and 132 are connected to the antenna parts 120A and 120B by the anisotropic conductive rubbers 150A and 150B (see FIG. 2B), respectively.

Two remaining terminals that are not connected to the wiring layers 131 and 132 by the bumps 141 and 142, of the four terminals 140A of the IC chip 140, are dummy terminals.

On the sub-substrate 130 illustrated in FIG. 4B, ends 131A and 132A of the wiring layers 131 and 132 are located at positions corresponding to two terminals 140A on a diagonal line, of four terminals 140A, and the wiring layers 131 and 132 are both patterned in an L-form.

The ends 131A and 132A of the wiring layers 131 and 132 are connected to the two terminals 140A on the diagonal line, of the four terminals 140A, via bumps 141 and 142, respectively. The other ends 131B and 132B of the wiring layers 131 and 132 are connected to the antenna parts 120A and 120B by the anisotropic conductive rubbers 150A and 150B (see FIG. 2B), respectively.

Two remaining terminals that are not connected to the wiring layers 131 and 132 by the bumps 141 and 142, of the four terminals 140A of the IC chip 140, are dummy terminals.

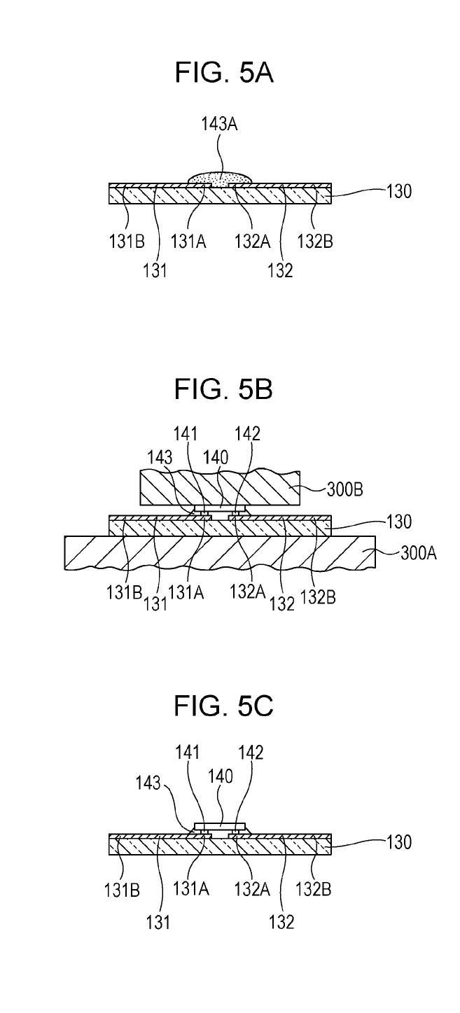

Next, a manufacturing method for the RFID tag 100 of the first embodiment will be described with reference to FIGS. 5 to 7.

FIGS. 5 to 7 illustrate manufacturing steps for the RFID tag 100 of the first embodiment. Cross sections illustrated in FIGS. 5 to 7 correspond to the cross section illustrated in FIG. 2B.

First, as illustrated in FIG. 5A, wiring layers 131 and 132 are formed on one surface of a sub-substrate 130, and an underfill material 143A is applied to an area between one end 131A of the wiring layer 131 and one end 132A of the wiring layer 132. In a state illustrated in FIG. 5A, the sub-substrate 130 is illustrated in a vertically reverse relation to the state illustrated in FIG. 2B.

Next, as illustrated in FIG. 5B, the sub-substrate 130 is placed on a press bed 300A for thermocompression bonding, and an IC chip 140 is placed on the sub-substrate 130 with bumps 141 and 142 being disposed therebetween. In this state, the IC chip 140 is pressed with heat from above by a pressing machine 300B.

As a result of the thermocompression bonding step of FIG. 5B, the IC chip 140 is mounted on the sub-substrate 130, as illustrated in FIG. 5C. The underfill material 143A illustrated in FIG. 5A is turned into an underfill portion 143 by being subjected to the thermocompression bonding step of FIG. 5B. In this state, two of four terminals 140A of the IC chip 140 (see FIGS. 4A and 4B) are connected to the wiring layers 131 and 132 on the sub-substrate 130 via the bumps 141 and 142, respectively.

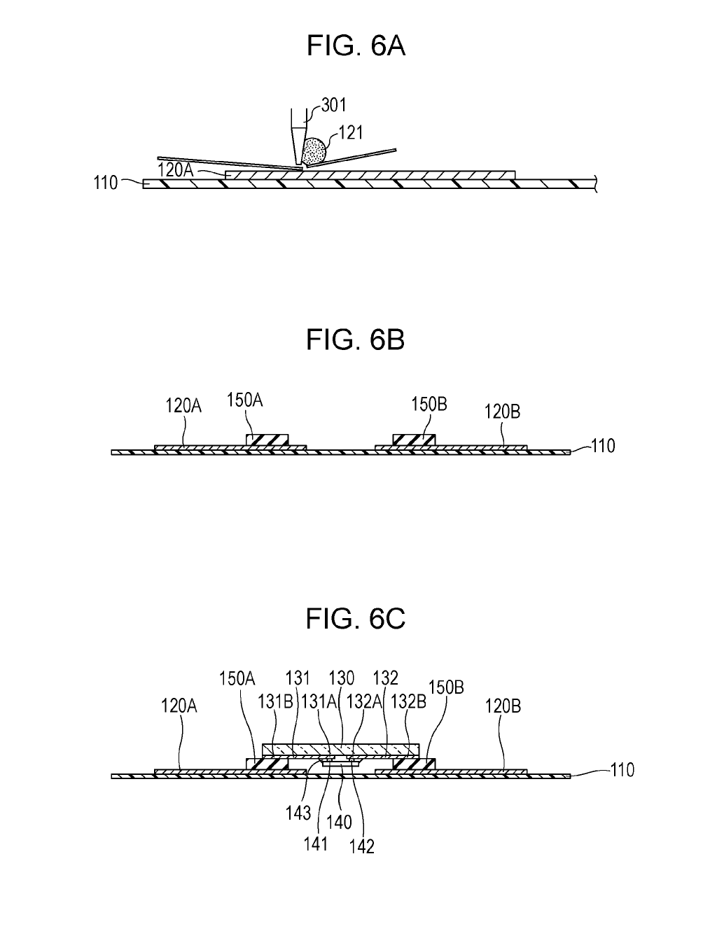

Next, as illustrated in FIG. 6A, antenna parts 120A and 120B are formed on an upper surface of a substrate 110. For example, the antenna parts 120A and 120B are formed by screen-printing Ag paste 121 on the upper surface of the substrate 110 with a squeegee 301. FIG. 6A illustrates a state in which the antenna part 120A is being formed.

Next, as illustrated in FIG. 6B, anisotropic conductive rubbers 150A and 150B are placed on predetermined positions on upper surfaces of the antenna parts 120A and 120B, respectively.

Next, as illustrated in FIG. 6C, the other ends 131B and 132B of the wiring layers 131 and 132 on the sub-substrate 130, on which the IC chip 140 is mounted, are placed on the anisotropic conductive rubbers 150A and 150B in alignment (superposed), respectively.

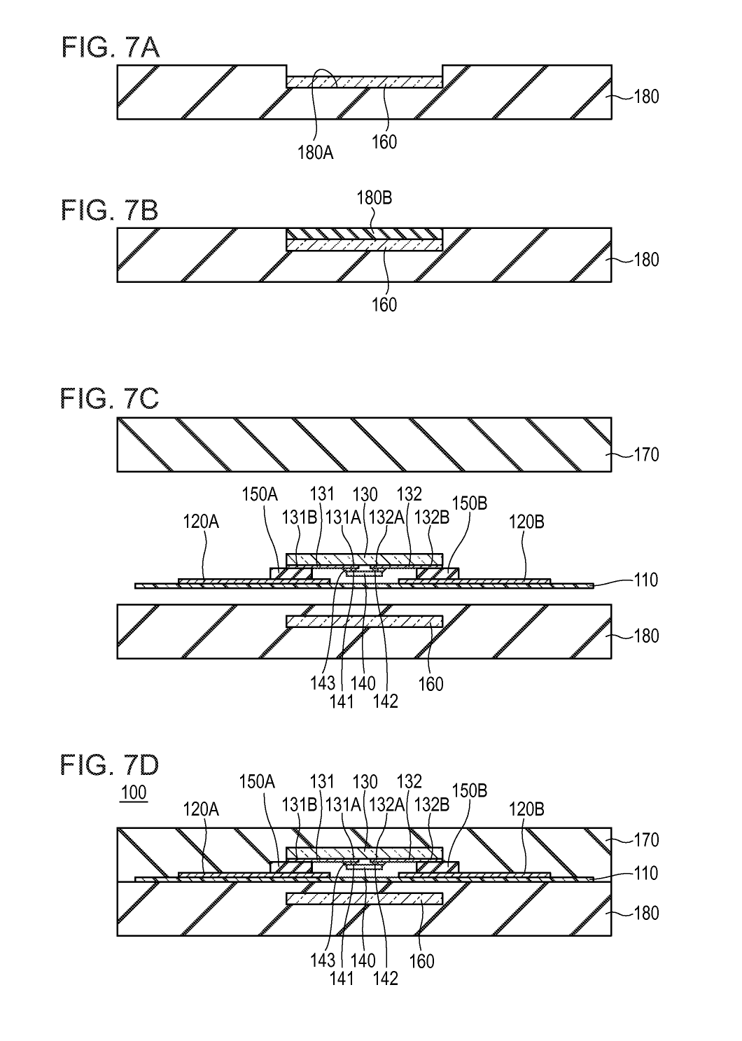

Next, a sub-substrate 160 is put in a hollow 180A of a cover part 180, as illustrated in FIG. 7A, and the same rubber material 180B as that for the cover part 180 is applied, as illustrated in FIG. 7B. When the rubber material 180B is applied on the sub-substrate 160, it is combined with the cover part 180. In this state, the sub-substrate 160 is sealed and enclosed by the cover part 180.

Next, the substrate 110 and the sub-substrate 130, which are superposed, as illustrated in FIG. 6C, are placed on the cover part 180, as illustrated in FIG. 7C, the cover part 170 is aligned from above, and peripheral portions of the cover parts 170 and 180 are bonded, for example, with adhesive, as illustrated in FIG. 7D.

In this state, the cover parts 170 and 180 seal the substrate 110, the antenna 120, the sub-substrate 130, the IC chip 140, the anisotropic conductive rubbers 150, and the sub-substrate 160. Through the above-described steps, an RFID tag 100 of the first embodiment is completed.

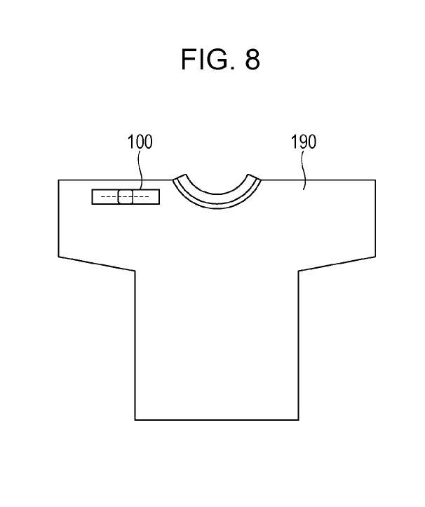

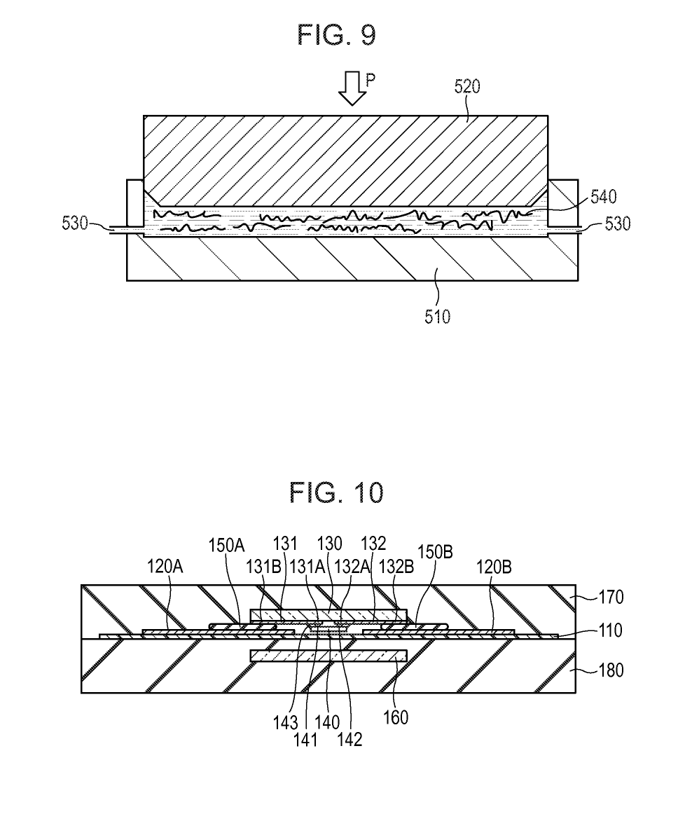

Here, with reference to FIGS. 8 and 9, descriptions will be given of a state in which the RFID tag 100 of the first embodiment is attached to a T-shirt and a water extracting operation performed by a dewaterer that performs press extraction.

FIG. 8 illustrates a state in which the RFID tag 100 of the first embodiment is sewn to a T-shirt 190. The RFID tag 100 is sewn to a right shoulder portion of the T-shirt 190. For example, the RFID tag 100 of the first embodiment may be used while being sewn to the T-shirt 190, as illustrated in FIG. 8, or may be sewn to a sheet.

FIG. 9 illustrates a dewaterer 500 that performs press extraction.

For example, the T-shirt 190 to which the RFID tag 100 of the first embodiment is sewn is washed and is then dewatered by the dewaterer 500.

The dewaterer 500 includes a container 510, a press piston 520, and a drain outlet 530. When a large amount of laundry 540 is put into the container 510, it is forcibly dewatered by being pressed with a pressure of, for example, about 30 to 50 kgf/cm² (see arrow P) by the press piston 520. Water extracted from the laundry 540 is drained through the drain outlet 530.

Even if the laundry 540 includes the T-shirt 190 illustrated in FIG. 8 and stress is applied to the RFID tag 100 sewn to the T-shirt 190, the RFID tag 100 is not broken and endures repetitive press extraction operations.

When the RFID tag 100 of the first embodiment is subjected to press extraction, it receives stress from various directions. Here, when stress is applied to the RFID tag 100 in a width direction (depth direction in FIG. 2B) or a length direction (lateral direction in FIG. 2B) of the substrate 110 and the sub-substrates 130 and 160, the substrate 110 and the sub-substrates 130 and 160 are hardly squashed by pressure, but a problem of breakage does not occur.

Further, when the RFID tag 100 is pressed in a thickness direction (thickness direction in FIG. 2B) of the substrate 110 and the sub-substrates 130 and 160, it is deformed to become thinner in the thickness direction, as illustrated in FIG. 10.

FIG. 10 is a cross-sectional view illustrating a deformed state of the RFID tag 100 of the first embodiment. The cross section of FIG. 10 corresponds to the cross section of FIG. 2B.

Referring to FIG. 10, the RFID tag 100 is pressed in the thickness direction because stress is applied from above the cover part 170 and from below the cover part 180.

In this state, the cover parts 170 and 180 are bent in the thickness direction, and the anisotropic conductive rubbers 150A and 150B are bent in the thickness direction. Since the substrate 100 has flexibility, when it is deformed by external stress applied to the RFID tag 100, the stress is also relaxed by the substrate 110.

Since not only the cover parts 170 and 180 but also the anisotropic conductive rubbers 150A and 150B are bent in this way, they relax the stress applied to the RFID tag 100.

In the RFID tag 100 of the first embodiment, the IC chip 140 is mounted on the sub-substrate 130, and the sub-substrate 130 is connected to the substrate 110 by the anisotropic conductive rubbers 150A and 150B that contract in the height (thickness) direction.

For this reason, even if external stress is applied to decrease the distance between the sub-substrate 130 and the substrate 110, it is relaxed by the anisotropic conductive rubbers 150A and 150B. Further, the IC chip 140 is located in the space between the sub-substrate 130 and the substrate 110, and the lower surface of the IC chip 140 is out of contact with the substrate 110. Hence, little stress is produced between the bumps 141 and 142 of the IC chip 140 and the wiring layers 131 and 132.

When such a stress is received, stresses in various directions may be applied to connecting portions between the anisotropic conductive rubbers 150A and 150B and the wiring layers 131 and 132. For example, a stress to twist the connecting portions or a stress to separate the connecting portions may be applied.

However, the anisotropic conductive rubbers 150A and 150B have elasticity and flexibility, and the connecting portions between the wiring layers 131 and 132 and the anisotropic conductive rubbers 150A and 150B are deformable.

For this reason, even if the RFID tag 100 receives external stress, the connecting portions between the wiring layers 131 and 132 and the anisotropic conductive rubbers 150A and 150B may be restricted from undergoing breakage such as a break in a wire.

Similarly, stresses in various directions may be applied to connecting portions between the anisotropic conductive rubbers 150A and 150B and the antenna parts 120A and 120B provided on the substrate 110. For example, a stress to twist the connecting portions or a stress to separate the connecting portions may be applied.

However, the anisotropic conductive rubbers 150A and 150B have elasticity and flexibility, and the connecting portions between the antenna parts 120A and 120B and the anisotropic conductive rubbers 150A and 150B are deformable.

For this reason, even if the RFID tag 100 receives external stress, the connecting portions between the antenna parts 120A and 120B and the anisotropic conductive rubbers 150A and 150B may be restricted from undergoing breakage such as a break in a wire.

Further, the RFID tag 100 of the first embodiment includes the sub-substrate 160 provided on the lower surface side of the substrate 110. The sub-substrate 160 has almost the same size as that of the sub-substrate 130, and is formed by a glass epoxy substrate, similarly to the sub-substrate 130.

For this reason, the IC chip 140 is protected between the sub-substrate 130 and the sub-substrate 160, and the stress is relaxed by the anisotropic conductive rubbers 150A and 150B and a portion of the cover part 180 located between the sub-substrate 160 and the substrate 110.

Therefore, in the RFID tag 100 of the first embodiment, the occurrence of breakage, such as a break in a wire, in the antenna parts 120A and 120B, the wiring layers 131 and 132, and the IC chip 140 may be suppressed by the sub-substrate 160 provided on the lower surface side of the substrate 110.

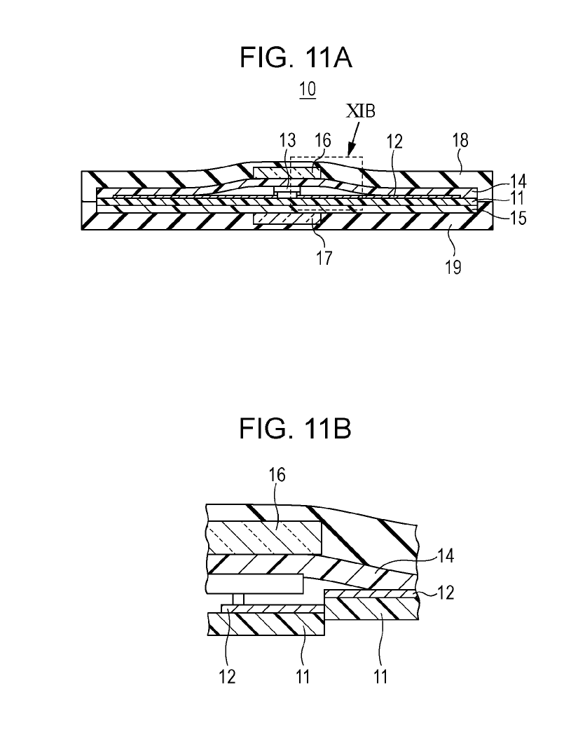

Here, with reference to FIGS. 11A and 11B, a description will be given of breakage that may be caused when external stress is applied to the RFID tag 10 illustrated in FIG. 1.

FIGS. 11A and 11B are cross-sectional views illustrating a state in which the RFID tag 10 of FIG. 1 receives external stress. FIG. 11A illustrates a cross section corresponding to the cross section of FIG. 1B, and FIG. 11B is an enlarged view of a portion XIB in the cross section of FIG. 11A.

Referring to FIG. 11A, when stress is applied from upper and lower sides of the cover parts 18 and 19, respectively, in the RFID tag 100, the base part 11 may be broken and a break in a wire may be caused in the antenna 12, as illustrated in FIG. 11B.

This is because, in the RFID tag 100 of the first embodiment, the stress may be relaxed by the anisotropic conductive rubbers 150A and 150B (see FIG. 2B), whereas, the RFID tag 10 of FIGS. 11A and 11B does not include a structure for relaxing the stress between the IC chip 13 and the base part 11.

For this reason, even if the RFID tag 100 of the first embodiment receives external stress, the stress is relaxed by the anisotropic conductive rubbers 150A and 150B. Hence, breakage, such as a break in a wire, may be restricted from being caused in the connecting portions of the IC chip 140, the wiring layers 131 and 132, and the antenna parts 120A and 120B.

Therefore, according to the first embodiment, even if stress is applied to the RFID tag 100 attached to a sheet or the like in a severe condition, for example, during press extraction, the occurrence of breakage, such as a break in a wire, may be suppressed.

According to the above-described first embodiment, it is possible to provide the RFID tag 100 having high durability.

According to the first embodiment, even if the RFID tag 100 is deformed, the IC chip 140 is protected by the space between the substrate 110 and the sub-substrate 130. This may restrict the connecting portions of the IC chip 140, the wiring layers 131 and 132, and the antenna parts 120A and 120B from suffering damage such as a break in a wire.

This is because the sub-substrate 130 with the IC chip 140 mounted on its lower surface and the substrate 110 provided on the lower side of the sub-substrate 130 are connected by the anisotropic conductive rubbers 150A and 150B, so that elastic deformation and electric connection are ensured between the sub-substrate 130 and the substrate 110.

While the RFID tag 100 of the first embodiment is subjected to press extraction while being attached to a sheet, it may be attached to goods other than the sheet. Moreover, damage, such as a break in a wire, may be suppressed even in a severe condition other than press extraction.

### Second Embodiment

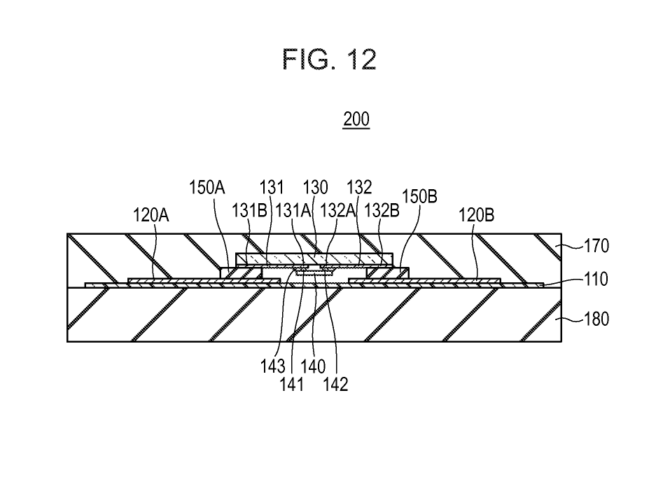

FIG. 12 is a cross-sectional view of an RFID tag 200 according to a second embodiment. The cross section illustrated in FIG. 12 corresponds to the cross section of the RFID tag 100 of the first embodiment illustrated in FIG. 2B.

The RFID tag 200 of the second embodiment has a structure such that the sub-substrate 160 is removed from the RFID tag 100 of the first embodiment. Correspondingly, the hollow 180A (see FIG. 7A) is not provided in a cover part 180. The cover part 180 in the RFID tag 200 of the second embodiment is shaped like a thin plate, similarly to a cover part 170.

Since other structures are similar to those adopted in the RFID tag 100 of the first embodiment, like constituent elements are denoted by like reference numerals, and descriptions thereof are skipped.

While the RFID tag 200 of the second embodiment does not include the sub-substrate 160 provided in the RFID tag 100 of the first embodiment, but a lower surface side of the RFID tag 200 is protected by the cover part 180.

Since a substrate 110 is formed by a PET film having flexibility, it has a certain degree of strength.

For this reason, even if the RFID tag 200 is deformed, the IC chip 140 is protected by a space between the substrate 110 and the sub-substrate 130. This may restrict connecting portions between the IC chip 140, wiring layers 131 and 132, and antenna parts 120A and 120B from suffering damage such as a break in a wire.

This is because the sub-substrate 130 with the IC chip 140 mounted on its lower surface and the substrate 110 provided on the lower side of the sub-substrate 130 are connected by anisotropic conductive rubbers 150A and 150B, so that elastic deformation and electric connection are ensured between the sub-substrate 130 and the substrate 110.

Therefore, according to the second embodiment, the RFID tag 200 having high durability may be provided although it does not include the sub-substrate 160, unlike the RFID tag 100 of the first embodiment.

While the RFID tags according to the exemplary embodiments have been described above, the disclosure is not limited to the specifically disclosed embodiments, and various modifications and alterations may be made without departing from the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An RFID tag comprising:
a first substrate having flexibility and configured to include an antenna provided on a first surface of the first substrate;
a second substrate;
an IC chip mounted on a first surface of the second substrate;
an anisotropic conductive rubber configured to contact the first substrate to the second substrate with the IC chip facing the first surface of the first substrate and to contact a terminal of the IC chip to the antenna; and
an exterior rubber configured to cover the first substrate, the second substrate, and the IC chip.

2. The RFID tag according to claim 1, wherein
the terminal of the IC chip is connected to a wiring layer mounted on the first surface of the second substrate, and
the anisotropic conductive rubber contacts the wiring layer to the antenna so as to connect the terminal of the IC chip to the antenna.

3. The RFID tag according to claim 1, wherein the second substrate is a plate-shaped substrate having rigidity.

4. The RFID tag according to claim 1, further comprising:
a third substrate provided on a side of a second surface of the first substrate and covered with the exterior rubber.

5. The RFID tag according to claim 4, wherein
the exterior rubber includes a first exterior rubber portion configured to cover the second substrate and a second exterior rubber portion configured to cover the side of the second surface of the first substrate, and
the third substrate is enclosed in the second exterior rubber portion.

6. The RFID tag according to claim 1, wherein
the anisotropic conductive rubber has conductivity in a thickness direction thereof and has elasticity and flexibility, and
a thickness of the anisotropic conductive rubber is more than a thickness of the IC chip in a state in which the anisotropic conductive rubber is contracted in the thickness direction.
